(19) United States
(12) Patent Application Publication
(10) Pub. No.: US 2013/0129088 A1
(43) Pub. Date: May 23, 2013

(54) METHOD AND SYSTEM FOR GENERATING UNPREDICTABLE PSEUDO-RANDOM NUMBERS

(71) Applicants: Gonzalo Álvarez Marañón, Madrid (ES); Veronica Fernandez Marmol, Madrid (ES); Luis Hernandez Encinas, Madrid (ES); Fausto Montoya Vitini, Las Matas (ES); Amalia Beatriz Orue Lopez, Las Matas (ES); Gerardo Pastor Degano, Madrid (ES); Miguel Emilio Romera Garcia, Madrid (ES)

(72) Inventors: Gonzalo Álvarez Marañón, Madrid (ES); Veronica Fernandez Marmol, Madrid (ES); Luis Hernandez Encinas, Madrid (ES); Fausto Montoya Vitini, Las Matas (ES); Amalia Beatriz Orue Lopez, Las Matas (ES); Gerardo Pastor Degano, Madrid (ES); Miguel Emilio Romera Garcia, Madrid (ES)

(73) Assignee: TELEFONICA, S.A, Madrid (ES)

(21) Appl. No.: 13/643,662

(22) PCT Filed: Dec. 24, 2009
(86) PCT No.: PCT/ES2009/070629

§ 371 Date: Feb. 5, 2013

(51) Int. Cl. H04L 9/08

(52) U.S. Cl. CPC H04L 9/0869
USPC 380/46

(57) ABSTRACT

The invention relates to a system for generating unpredictable pseudorandom numbers in a chaotic manner, comprising discrete chaotic map processing means and an XOR gate for generating unpredictable pseudorandom numbers. The method is based on introducing a high degree of entropy in the system by cyclically shifting chaotic maps to the right.

### OBJECT OF THE INVENTION

As expressed in the title of this specification, the present invention relates to a method and to a system for generating sequences of unpredictable pseudorandom numbers in a chaotic manner. The main field of application is cryptography, which affords it a number of applications associated with all aspects relating to information security. For that purpose, the present invention comprises a system for generating sequences of unpredictable pseudorandom numbers based on a combination of discrete chaotic maps the association of which results in a powerful system for generating said numbers. Said generator is basically made up of a discrete chaotic map processor and an XOR gate performing the bit-by-bit modulo 2 addition of the result of processing discrete chaotic maps to obtain the pseudorandom numbers.

### BACKGROUND OF THE INVENTION

Cryptography is the science dedicated to studying all the aspects associated with information security, such as confidentiality, data integrity, entity authentication and source data authentication. There are a number of solutions in the state of the art implementing cryptographic applications based on known mathematical algorithms.

The solutions of the state of the art up until the present invention involve pseudorandom number generators (PRNG). The most well-known pseudorandom number generators include the following:
Linear congruential generators (LCG), which are the most widely used generators for simulations and for implementing pseudorandom algorithms.
Linear feedback shift register (LFSR) and its combinations, such as its non-linear combinations or its irregular synchronizations.
Typical cryptographic primitive functions, such as AES, DES, SHA, etc., when their input is a counter.

The most typical problems when implementing a ciphering solution consist of finding a suitable compromise between the strength of the solution and the resources necessary for carrying out said solution. The solutions needing few resources are usually vulnerable to external attacks. Other solutions involving robust systems of ciphering consume a large amount of resources and often slow the system down.

The linear congruential generator is the most well-known, oldest and best studied algorithm of all those existing in the state of the art. It was proposed by Lehmer in 1949 and is among the fastest number algorithms. The main drawback of the linear congruential generator is that it is completely predictable if several samples generated by said generator are known.

Another solution is based on implementing generators based on linear feedback shift registers (LFSR). These are a type of generators that can be efficiently built by means of electronic circuits. This device is capable of generating long sequences of pseudorandom numbers with a perfect statistical distribution. The main drawback of this solution is that it is not secure enough given its linear character.

Given the low security provided by solutions based on linear feedback shift register (LFSR) generators, said solutions are often used as basic building blocks for more complex pseudorandom number generators.

Based on the solutions considered above, the alternatives found in the state of the art are based on more or less complex combinations of said solutions with other mechanisms which can often suffer the same limitations as the originals.

“Non-linear filtering” introducing non-linear functions in the output of LCG or LFSR generators is among the combinations indicated above. Another option is the “non-linear combination” of LFSR generators of different lengths of sequences of numbers generated in the feedback of the generator, such that the output is a function of part of the input states of all LFSR generators. Other solutions are “non-linear update” of the memory used by the generator or “irregular synchronization”.

Therefore, it would be desirable to find a system for generating unpredictable pseudorandom numbers in a chaotic manner the implementation of which is low-cost in terms of resources, that is very strong against attacks and fast to generate said unpredictable pseudorandom numbers.

### DESCRIPTION OF THE INVENTION

To achieve the objectives and avoid the drawbacks indicated above, the invention consists of a method and a system for generating unpredictable pseudorandom numbers, said system comprising an unpredictable pseudorandom number generator based on a combination of discrete chaotic maps.

The novel system of the present invention is capable of recursively generating unpredictable pseudorandom numbers forming a sequence quickly, with a low cost in resources and resistant to external attacks. It is possible to generate said sequences of random numbers with high bit rates. Furthermore, the sequences of pseudorandom numbers generated by the system of the present invention are completely unpredictable; when a limited portion of generated numbers is known, it is impossible to find out the numbers that were generated previously or estimate those that will be generated in the future. The present invention uses a “key” for generating unpredictable pseudorandom numbers which in no case can be discovered by deduction by means of mathematical analysis. This is because the inverse function of the multiple recursive function generating the sequence of unpredictable pseudorandom numbers is a multivalued function.

Another advantage of the present application is that it can be used as a one-way conversion function. It is also possible to apply it as a stream cipher device, such as a Message Authentication Code (MAC) generator device, or such as a device for generating One-time Passwords (OTP), among other cryptographic protocols. Furthermore, the sequences of numbers generated by the present invention show perfect random statistics, being indistinguishable from an authentic random sequence.

The system described in the present invention is based on a generator, which is based on a combined multiple recursion of several discrete chaotic dynamical sub-systems, also referred to as discrete chaotic maps. The mechanism of combination consists of the bit-by-bit modulo 2 addition (XOR) of the output of each dynamical sub-system. The sequence of numbers generated is a non-reversible function of a set of several past numbers of the same sequence. The output xₙ in moment “n” is defined by the formula:

xₙ=[f₁(xₙ₋₁)]⊕[f₂(xₙ₋₂)]⊕ . . . ⊕[fⱼ(xₙ₋ⱼ)]⊕ . . . ⊕[fₖ(xₙ₋ₖ)];

wherein “xₙ₋ⱼ” is the number generated in a previous moment “n−j”, “xₙ₋ₖ” is the number generated in a previous moment “n−k”, “xₙ₋₂” is the number generated in a previous moment “n−2”, “xₙ₋₁” is the number generated in a previous moment “n−1”; “k” is the total number of the different discrete chaotic maps involved, which must comply with k≧2; the function fⱼ(xₙ₋ⱼ) is the chaotic map “j” applied on the number generated in moment “n−j”, 1≦j≦k and “⊕” being the bit-by-bit modulo 2 addition (XOR).

Function fⱼ(xₙ₋ⱼ) is a discrete chaotic map defined as:

fⱼ(xₙ₋ⱼ)=[(aⱼxₙ₋ⱼ+cⱼ)mod m]>>>rⱼ;

wherein “aⱼ” and “cⱼ” are two randomly selected integers referred to as “key”; “rⱼ” and “m” are two integers controlling the system but not forming part of the “key”; operator “mod” represents the modulus function; operator “>>>” represents the cyclic shift to the right function; and where the values of the key must verify that 1≦aⱼ≦m and 1≦cⱼ≦m; for all the values of “j” comprised between 1 and “k”, both values 1 and “k” included.

The system of the present invention comprises external values referred to as “seed” which serve to both initialize the system and to change the changing the starting point of the sequences generated in any desired moment.

This chaotic map allows generating the same sequences of random numbers repeatedly if the key is maintained. On the other hand, if the key is maintained but the external values referred to as seed are modified, the system generates the same sequences but with different starting points.

Therefore, the system is controlled by the external values referred to as “seed” and by the numbers forming the “key”. Furthermore, the maximum length of the sequence of random numbers that the system can generate depends on the number of discrete chaotic maps that are used, as well as on the amount of bits used to code each number. The variations of all the preceding technical features allow the system to adapt to any embodiment needs.

Although the part of the expression for fⱼ(xₙ₋ⱼ) in brackets is known in the state of the art, the cyclic shift to the right function “>>>” is an innovation because it introduces a high degree of entropy in the system, which entails a high levels of randomness in the generated data sequence.

The system for generating unpredictable pseudorandom numbers in a chaotic manner of the present invention comprising, for predetermined implementation values comprising at least one word size “S” and a number of discrete chaotic maps “k”, at least:
a chaotic-based unpredictable pseudorandom number generator;
a parallel load module;
an output register storing the generated sequence comprised by concatenating the generated numbers; and,
an input register storing “k” initialization values y₁ to yₖ, said initialization values being referred to as “seed” in the present invention without this representing any limitation thereof whatsoever.

The chaotic-based unpredictable pseudorandom number generator additionally comprises at least:
“k” processing means MP1 to MPK for processing “k” discrete chaotic maps f₁(xₙ₋₁) to fₖ(xₙ₋ₖ), fⱼ(xₙ₋ⱼ) being:

fⱼ(xₙ₋ⱼ)=[(aⱼxₙ₋ⱼ+cⱼ)mod m]>>>rⱼ
where the coefficients “aⱼ” and “cⱼ” are two randomly selected integers referred to as “key” such that 1≦aⱼ≦m, 1≦cⱼ≦m; “xₙ₋ⱼ” is the random number generated in the previous moment “n−j”; “rⱼ” and “m” two integers; “mod” the modulus function; “j” an integer such that 1≦j≦k; operator “>>>” the shift to the right function;
an XOR logic gate performing the bit-by-bit modulo 2 addition from the result obtained by “k” processing means MP1 to MPK of “k” discrete chaotic maps f₁(xₙ₋₁) to fₖ(xₙ₋ₖ), obtaining the unpredictable pseudorandom number “xₙ”:

xₙ=[f₁(xₙ₋₁)]⊕ . . . ⊕[fₖ(xₙ₋ₖ)]
a cyclic shift module computing the shift to the right in “rⱼ” bits of the binary number obtained when the discrete chaotic map fⱼ(xₙ₋ⱼ) is processed by the processing means “j”, “j” being a number such that 1≦j≦k; said cyclic shift module is located in a location option selected from a location comprised in each of “k” processing means and a location independent of “k” processing means connected to said “k” processing means and to the XOR logic gate;
“k” memory elements EM1 to EMK storing data selected from the last “k” unpredictable pseudorandom numbers generated by the generator when the system has already been initialized, and “k” initialization values y₁ to yₖ with word sizes of “S” bits referred to as “seed” coming from the input register when an action selected from initializing the system and changing the starting point is performed;
“k” commutators CM1 to CMK which allow loading “k” memory elements EM1 to EMK with “k” external values referred to as “seed” y₁ to yₖ;
an output connector connecting the output of the XOR logic gate with the output register for adding the unpredictable pseudorandom number “xₙ” generated in moment “n” to the sequence of numbers stored in said output register and made up of the pseudorandom numbers generated in the previous moments; and,
“k” input connectors for loading “k” initialization values y₁ to yₖ referred to as “seed” in “k” commutators CM1 to CMK, as well as a load input connector connecting the parallel load module with the control input of “k” commutators CM1 to CMK, and a generated number input connector connecting the output connector with the input of memory element number one EM1.

On the other hand, the innovative method for generating unpredictable pseudorandom numbers in a chaotic manner comprising, for predetermined implementation values comprising at least one word size “S” and a number of discrete chaotic maps “k”, said number of discrete chaotic maps being at least 2 in number, at least the following steps:
i) executing an order to load “k” initialization values referred to as “seed” in parallel from a parallel load module, each initialization value comprising a word length of “S” bits;
ii) reading “k” initialization values referred to as “seed” in an input register;
iii) opening “k” commutators;
iv) loading “k” memory elements with “k” initialization values in parallel when an action selected from starting the system and changing the starting point of a generated sequence is required;
v) updating the content of “k” memory elements numbered one to “k” which, for an implementation in which said memory elements are each interconnected with the following element; where the last element with number “k” is not connected to any other element, and where memory element number one receives at its input the unpredictable pseudorandom number generated, by means of the following sub-steps:
   discarding the content of memory element number “k”;
   moving the content of each memory element “h” to memory element number “h+1” for values of “h” such that 1≦h≦k; and,
   loading memory element number “k” with the last value of the unpredictable pseudo-chaotic number generated “xₙ”;
   when the system has previously been initialized;
vi) processing “k” discrete chaotic maps fₖ(xₙ₋ₖ) by means of “k” processing means; “k” chaotic maps being those defined by:

fⱼ(xₙ₋ⱼ)=[(aⱼxₙ₋ⱼ+cⱼ)mod m]>>>rⱼ;
wherein “aⱼ” and “cⱼ” are two randomly selected integers referred to as “key”; “rⱼ” and “m” are two integers; operator “mod” represents the modulus function; operator “>>>” represents the cyclic shift to the right function; and where the values of the key must verify that 1≦aⱼ≦m and 1≦cⱼ≦m; for all the values of “j” comprised between 1 and “k”, both included;
vii) computing the bit-by-bit modulo 2 addition, XOR, of the result of processing “k” chaotic maps, generating a new unpredictable pseudorandom number “xₙ”:

xₙ=[f₁(xₙ₋₁)]⊕ . . . ⊕[fₖ(xₙ₋ₖ)]
viii) adding the generated unpredictable pseudorandom number “xₙ” to the sequence generated and stored in the output register.
   Where steps i) to iv) described above are furthermore only performed once to carry out an action selected from initializing the system and changing the starting point of the generated sequence, and where steps v) to viii) are loop executed until the generated sequence contains the amount of unpredictable pseudorandom numbers established by a predetermined number.

### BRIEF DESCRIPTION OF THE DRAWINGS

FIG. 1 shows a block diagram of the system for generating unpredictable pseudorandom numbers according to the present invention in the most generic implementation form.

FIG. 2 shows a flow chart of the method for generating unpredictable pseudorandom numbers according to the present invention in the most generic implementation form.

FIG. 3 shows a block diagram of the system for generating unpredictable pseudorandom numbers according to the present invention for an implementation with two discrete chaotic maps and a word size of 64 bits.

FIG. 4 shows a flow chart of the method for generating unpredictable pseudorandom numbers according to the present invention for an implementation with two discrete chaotic maps and a word size of 64 bits.

FIG. 5 shows a block diagram of the system for generating unpredictable pseudorandom numbers according to the present invention for an implementation with six discrete chaotic maps and a word size of 32 bits.

FIG. 6 shows a flow chart of the method for generating unpredictable pseudorandom numbers according to the present invention for an implementation with six discrete chaotic maps and a word size of 32 bits.

FIG. 7 shows an implementation example of the present invention applied to a stream cipher device.

FIG. 8 shows an implementation example of the present invention applied to a Message Authentication Code (MAC) generator device.

### DESCRIPTION OF SEVERAL EMBODIMENTS OF THE INVENTION

Several embodiments of the invention are described below with an illustrative and non-limiting character using the reference numbers used in the drawings.

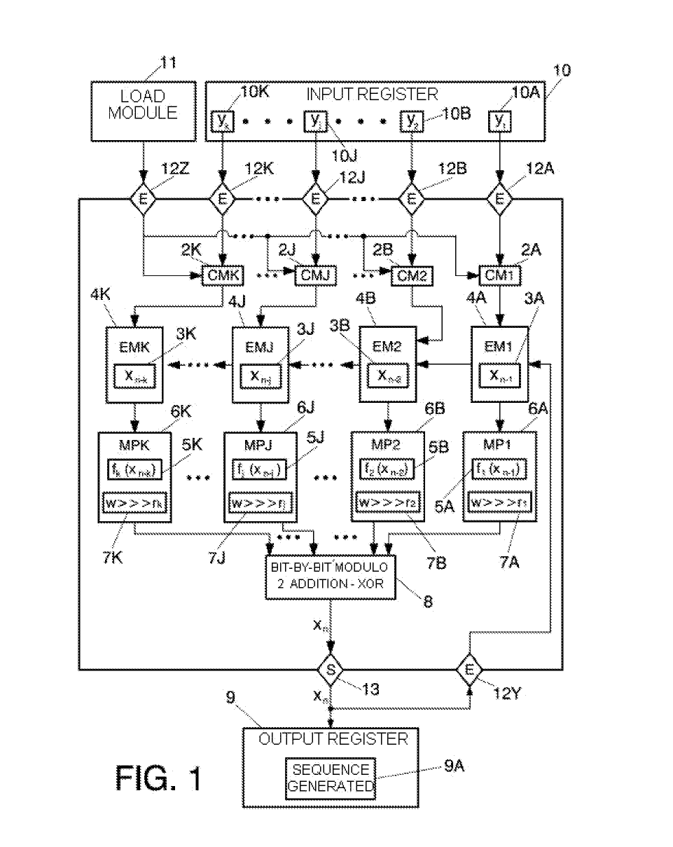

FIG. 1 shows a block diagram of the system for generating unpredictable pseudorandom numbers according to the present invention. To determine the configuration or implementation of the system, it is necessary to at least predetermine the word size “S” and the number of discrete chaotic maps “k”. In the broadest embodiment shown in FIG. 1, the system comprises at least the following elements:
a chaotic-based unpredictable pseudorandom number generator (1);
a parallel load module (11);
an output register (9) storing the generated sequence (9A) comprised by concatenating the generated numbers “xₙ”; and,
an input register (10) storing “k” initialization values y₁ (10A), y₂ (10B), . . . , yⱼ; (10J), . . . , yₖ (10k), said initialization values being referred to as “seed” in the present invention.

The chaotic-based unpredictable pseudorandom number generator (1) additionally comprises at least:
“k” processing means MP1 (6A), MP2 (6B), . . . , MPJ (6J), . . . , MPK (6K) for processing “k” discrete chaotic maps f₁(xₙ₋₁) (5A), f₂(xₙ₋₂) (5B), . . . , fⱼ(xₙ₋₁) (5J), . . . , fₖ(xₙ₋ₖ) (5K), fⱼ(xₙ₋₁) being:

fⱼ(xₙ₋ⱼ)=[(aⱼxₙ₋ⱼ+cⱼ)mod m]>>>rⱼ
the coefficients “aⱼ” and “cⱼ” being two randomly selected integers referred to as “key” such that 1≦aⱼ≦m, 1≦cⱼ≦m; xₙ₋ⱼ is the random number generated in the previous moment “n−j”; “rⱼ” and “m” two integers; “mod” the modulus function; “j” an integer such that 1≦j≦k; operator “>>>” the shift to the right function which is carried out by “k” cyclic shift modules (7A,7B, . . . , 7J, . . . , 7K) computing the shift to the right in “rⱼ” bits of the binary number obtained when the discrete chaotic map fⱼ(xₙ₋ⱼ) is processed by the processing means “j”; said “k” cyclic shift modules (7A,7B, . . . , 7J, . . . , 7K) are located in a location option selected from a location comprised in each of “k” processing means and a location independent of “k” processing means connected to said “k” processing means and to the XOR logic gate (8);
an XOR logic gate (8) performing the bit-by-bit modulo 2 addition from the result obtained by “k” processing means MP1 (6A), MP2 (6B), . . . , MPJ (6J), . . . , MPK (6K) for processing “k” discrete chaotic maps f₁(xₙ₋₁) (5A), f₂(xₙ₋₂) (5B), . . . , fⱼ(xₙ₋ⱼ) (5J), . . . , fₖ(xₙ₋ₖ) (5K), obtaining the unpredictable pseudorandom number xₙ:

xₙ=[f₁(xₙ₋₁)]⊕[f₂(xₙ₋₂)]⊕ . . . ⊕[fⱼ(xₙ₋ⱼ)]⊕ . . . ⊕[fₖ(xₙ₋ₖ)];
“k” memory elements, EM1 (4A), EM2 (4B), . . . , EMJ (4J), EMK (4K) storing data selected from the last “k” unpredictable pseudorandom numbers generated by the generator when the system has already been initialized, and “k” initialization values y₁ (10A), y₂ (10B), . . . , yⱼ(10J), . . . , yₖ (10k) with word sizes of “S” bits referred to as “seed” coming from the input register (10) when an action selected from initializing the system and changing the starting point is performed;
“k” commutators CM1 (2A), CM2 (2B), . . . CMJ (2J), . . . CMK (2K) which allow loading “k” memory elements EM1 (4A), EM2 (4B), . . . EMJ (4J), . . . EMK (4K) with “k” external values referred to as “seed” y₁ (10A), y₂ (10B), . . . , yⱼ (10J), . . . , yₖ (10K);
an output connector (13) connecting the output of the XOR logic gate (8) with the output register (9) for adding the unpredictable pseudorandom number “xₙ” generated in moment “n” to the sequence of numbers (9A) stored in said output register (9) and made up of the pseudorandom numbers generated in the previous moments; and,
“k” input connectors (12A, 12B, . . . , 12J, . . . , 12K) for loading “k” initialization values y₁ (10A), y₂ (10B), . . . , yⱼ(10J), yₖ (10K) referred to as “seed” in “k” commutators CM1(2A), CM2(2B), . . . CMJ(2J), . . . CMK(2K), as well as a load input connector (12Z) connecting the parallel load module (11) with the control input of “k” commutators CM1(2A), CM2(2B), . . . CMJ(2J), . . . CMK(2K), and a generated number input connector (12Y) connecting the output connector (13) with the input of memory element EM1 (4A).

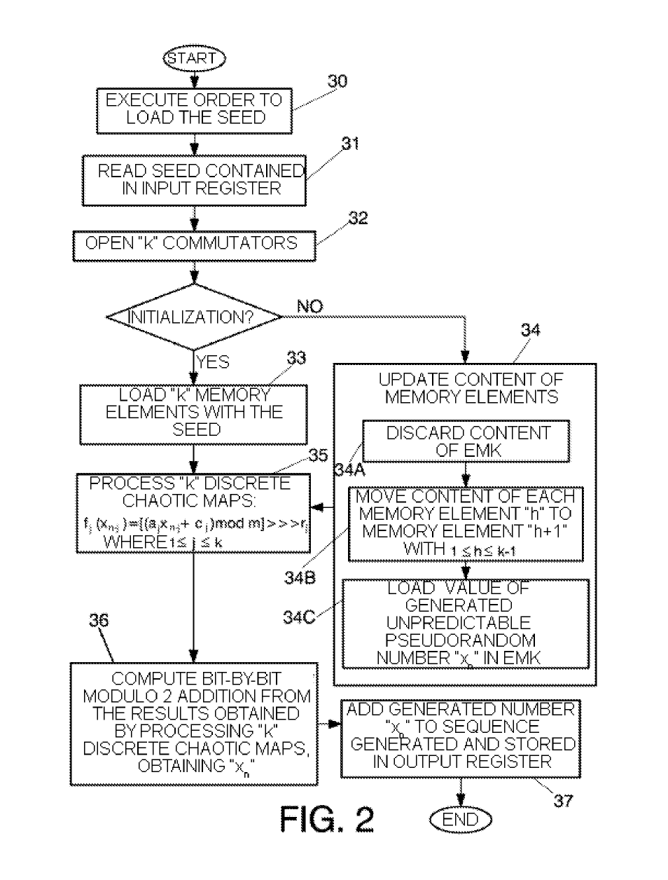

FIG. 2 shows a flow chart of the method for generating unpredictable pseudorandom numbers according to the present invention. Said flow chart depicts the method of the present invention for an implementation of the system shown in FIG. 1.

Said method comprises at least the following steps:
i) executing (30) an order to load “k” initialization values referred to as “seed” in parallel from a parallel load module, each initialization value comprising a word length of “S” bits;
ii) reading (31)“k” initialization values referred to as “seed” in an input register;
iii) opening (32) “k” commutators;
iv) loading (33) “k” memory elements with “k” initialization values in parallel when an action selected from starting the system and changing the starting point of a generated sequence is required;
v) updating (34) the content of “k” memory elements numbered one to “k” which, for an implementation in which said memory elements are each interconnected with the following element; where the last element with number “k” is not connected to any other element, and where memory element number one receives at its input the unpredictable pseudorandom number generated by means of the following sub-steps:
   discarding (34A) the content of memory element number “k”;
   moving (34B) the content of each memory element “h” to memory element number “h+1”, “h” being an integer such that 1≦h<k; and,
   loading (34C) memory element number one EM1 with the last value of the unpredictable pseudo-chaotic number generated “xₙ”;
   when the system has previously been initialized;
vi) processing (35) “k” discrete chaotic maps fₖ(xₙ₋ₖ) by means of “k” processing means; “k” chaotic maps being those defined by:

fₖ(xₙ₋ₖ)=[(aₖxₙ₋ₖ+cₖ)mod m]>>>rₖ;
each pair of coefficients “aₖ” and “cₖ” being two randomly selected integers referred to as “key” such that 1≦aₖ≦m, 1≦cₖ≦m; xₙ₋ₖ is the random number generated in the previous moment “n−k”; “rₖ” and “m” two integers; “mod” the modulus function; operator “>>>” the shift to the right function;
vii) computing (36) the bit-by-bit modulo 2 addition, XOR, of the result of processing “k” chaotic maps, generating a new unpredictable pseudorandom number “xₙ”:

xₙ=[f₁(xₙ₋₁)]⊕ . . . ⊕[fₖ(xₙ₋ₖ)];
viii) adding (37) the generated unpredictable pseudorandom number “xₙ” to the sequence generated and stored in the output register;
   where steps i) to iv) described above are furthermore only performed once to carry out an action selected from initializing the system and changing the starting point of the generated sequence, and where steps v) to viii) are loop executed until the generated sequence contains the amount of unpredictable pseudorandom numbers established by a predetermined number. Said predetermined number must be less than the period P of the generator to maintain system strength.

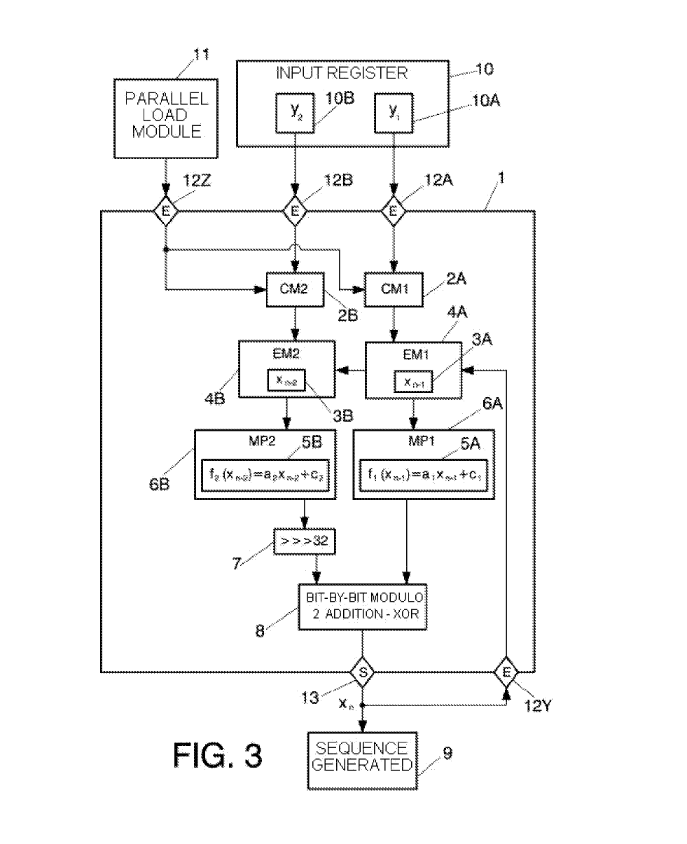

FIG. 3 shows a block diagram of the system for generating unpredictable pseudorandom numbers according to the present invention. To determine the configuration of the system, it is only necessary to determine the word size and a number of discrete chaotic maps. The diagram shown in FIG. 3 corresponds to an implementation where the word size is 64 bits, S=64, with a number of chaotic maps equal to 2, k=2. This design is quick to be implemented and entails low resource consumption for generating the pseudorandom numbers. The maximum period of generator P with said configuration is 2^{(S·k)}, i.e., P=2¹²⁸≈3.4 10³⁸. As the condition for the generated sequence M is that it must be less than period P, this implementation of the generator is suitable for a sequence size of up to 10³⁰ numbers.

The system according to the implementation shown in FIG. 3 comprises a chaotic-based unpredictable pseudorandom number generator (1), a parallel load module (11), an output register (9) storing the generated sequence comprised by concatenating the generated numbers, and an input register (10) storing initialization values y₁ (10A) and y₂ (10B), said initialization values being referred to as “seed” in the present invention.

The unpredictable pseudorandom number generator (1) shown in FIG. 3 additionally comprises the following elements:
two processing means MP1 (6A) and MP2 (6B) for processing two discrete chaotic maps f₁(xₙ₋₁) (5A) and f₂(xₙ₋₂)(5B);
an XOR logic gate (8) performing the bit-by-bit modulo 2 addition from the result obtained by the two processing means MP1 (6A) and MP2 (6B) for processing the two discrete chaotic maps f₁(xₙ₋₁) (5A) and f₂(xₙ₋₂)(5B);
a cyclic shift module (7) computing the 32 bit shift to the right of the binary number it has at its input, i.e., the number obtained from processing the discrete chaotic map f₂(xₙ₋₂) by the processing means MP2; said cyclic shift module (7) is located in a location option selected from a location comprised in the processing means MP2 and a location independent of said module;
two memory elements, EM1 (4A) and EM2 (4B) storing the unpredictable pseudorandom numbers generated by the generator in the two previous moments “n−1” and “n−2” when the system has already been initialized, or the two initialization values y₁ (10A) and y₂ (10B) with word sizes of 64 bits referred to as “seed” coming from the output register (10) when the system is initialized or the starting point is changed;
two commutators CM1 (2A) and CM2 (2B) which allow loading the two memory elements EM1 (4A) and EM2 (4B) with the two external values referred to as “seed” y₁ (10A) and y₂ (10B);
a first input connector (12A) and a second input connector (12B) for loading the external values referred to as “seed” y₁ (10A) and y₂ (10B) in two commutators CM1 (2A) and CM2 (2B), as well as a load input connector (12Z) connecting the parallel load module (11) with the control input of two commutators CM1 (2A) and CM2 (2B);
an output connector (13) connecting the output of the XOR logic gate (8) with the output register (9) for adding the unpredictable pseudorandom number “xₙ” generated in moment “n” to the sequence of numbers stored in said output register (9) and made up of the pseudorandom numbers generated in the previous moments.

The generator additionally comprises a generated number input connector (12Y) connecting the output connector (13) with the input of memory element EM1 (4A) storing the unpredictable pseudorandom number in moment “n−1” so that said element can be updated with the unpredictable pseudorandom number “xₙ”. In the same manner, memory elements EM1 (4A) and EM2 (4B) are interconnected to update their content when a new unpredictable pseudorandom number is generated. Therefore, the content of the memory element EM2 (4B) storing the unpredictable pseudorandom number in moment “n−2” is replaced with the content of memory element EM1 (4A) storing the unpredictable pseudorandom number in moment “n−1”, and this is replaced with the unpredictable pseudorandom number generated in moment “n”.

The two chaotic map processing means MP1 (6A) and MP2 (6B) compute the two functions f₁(xₙ₋₁) (5A) and f₂(xₙ₋₂) (5B) defining the discrete chaotic maps, said functions being:

f₁(xₙ₋₁)=[(a₁xₙ₋₁+c₁)mod 2⁶⁴];

f₂(xₙ₋₂)=[(a₂xₙ₋₂+c₂)mod 2⁶⁴];

coefficients “a₁”, “a₂”, “c₁” and “c₂” being four randomly selected integers referred to as “key”; xₙ₋₁ and xₙ₋₂ are the unpredictable pseudorandom numbers generated in the previous moments “n−1” and “n−2”, respectively.

Therefore, the unpredictable pseudorandom number “xₙ” obtained in moment “n” is:

xₙ=[[(a₁xₙ₋₁+c₁)mod 2⁶⁴]⊕[[(a₂xₙ₋₂+c₂)mod 2⁶⁴]>>>32 ]];

where “mod” is the modulus function, operator “>>>” the cyclic shift to the right function and where it is further found that 1≦aⱼ≦m and 1≦cⱼ≦m.

The implementation (not shown) of the cyclic shift module (7) in a unit external to both the processing means and to the unpredictable pseudorandom number generator (1) allows adding an additional degree of security to the system of the present invention because said cyclic shift module (7) is what generates entropy of the system.

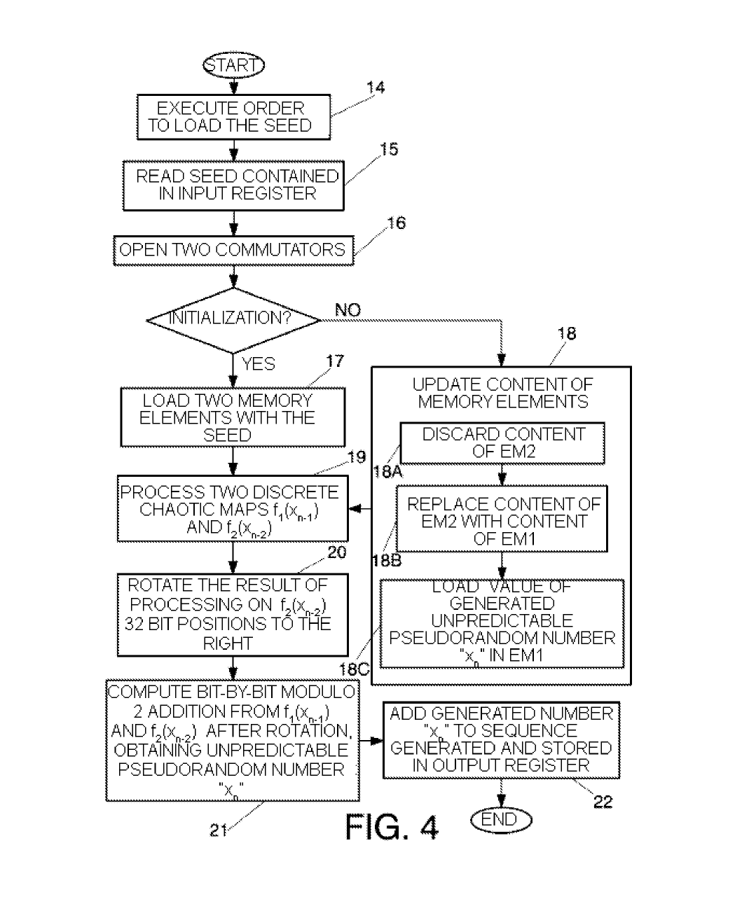

FIG. 4 shows a flow chart of the method for generating unpredictable pseudorandom numbers according to the present invention. Said flow chart depicts the method of the present invention for an implementation of the system shown in FIG. 3, i.e., for a system determined by a word size of 64 bits and two discrete chaotic maps. Said method shown in FIG. 4 with which unpredictable pseudorandom numbers are obtained in a chaotic manner comprises the following steps:
i) executing (14) the order to load initialization values referred to as “seed” in parallel from the parallel load module;
ii) reading (15) initialization values y₁ and y₂ referred to as “seed” in the input register, each value y₁ and y₂ comprising a word length of 64 bits;
iii) opening (16) commutators CM1 and CM2;
iv) loading (17) memory elements EM1 and EM2 with initialization values y₁ and y₂ in parallel if the system is initialized or if changing the starting point of the generated sequence is required;
v) updating (18) the content of memory elements EM1 and EM2: discarding (18A) the content of memory element EM2 containing the unpredictable pseudorandom number generated in moment “n−2”; replacing (18B) the content of EM2 with the content of memory element EM1; and loading (18C) memory element EM1 with the last value of the unpredictable pseudo-chaotic number generated “xₙ”;
   when the system is not initialized;
vi) processing (19) the two discrete chaotic maps f₁(xₙ₋₁) and f₂(xₙ₋₂) by means of the two processing means MP1 and MP2; the two chaotic maps being those defined by:

f₁(xₙ₋₁)=[(a₁xₙ₋₁+c₁)mod 2⁶⁴];

f₂(xₙ₋₂)=[(a₂xₙ₋₂+c₂)mod 2⁶⁴];
vii) rotating (20) the result obtained from processing chaotic map f₂(xₙ₋₂) 32 bit positions to the right;
viii) computing (21) the bit-by-bit modulo 2 addition, XOR, from the result obtained in the two preceding steps, i.e., the result of processing two chaotic maps f₁(xₙ₋₁) and f₂(xₙ₋₂) with the subsequent rotation of f₂(xₙ₋₂), generating a new unpredictable pseudorandom number “xₙ”;
ix) adding (22) the generated unpredictable pseudorandom number “xₙ” to the sequence generated and stored in the output register.

Steps i) to iv) described above are only performed once for initializing the system or for changing the starting point. In contrast, steps v) to ix) are loop executed until the generated sequence contains the amount of unpredictable pseudorandom numbers established by a predetermined number. Said predetermined number must be less than the period P of the generator.

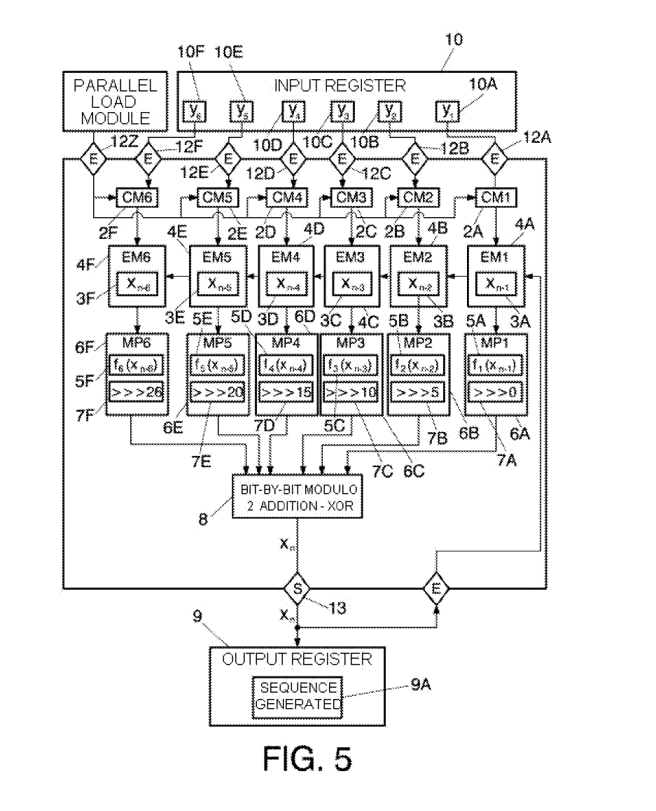

FIG. 5 shows a block diagram of the system for generating unpredictable pseudorandom numbers according to the present invention. The diagram shown in FIG. 5 corresponds to an implementation where the word size is 32 bits, S=32, with a number of chaotic maps equal to 6, k=6. The maximum period of the generator P with said configuration is 2^{(S·k)}, i.e., P=2¹⁹²≈10⁵⁹. As the condition for the generated sequence M is that it must be much less than period P, this implementation of the generator is suitable for a sequence size of up to 10⁵⁰ numbers.

The system according to the implementation shown in FIG. 5 comprises a chaotic-based unpredictable pseudorandom number generator (1), a parallel load module (11), an output register (9) storing the generated sequence comprised by concatenating the generated numbers, and an input register (10) storing initialization values y₁ (10A), y₂ (10B), y₃ (10E), y₄ (10D), y₅ (10E) and y₆ (10F), said initialization values being referred to as “seed” in the present invention.

The unpredictable pseudorandom number generator (1) shown in FIG. 5 additionally comprises the following elements:
six processing means MP1 (6A), MP2 (6B), MP3 (6C), MP4 (6D), MP5 (6E) and MP6 (6F) for processing six discrete chaotic maps f₁(xₙ₋₁) (5A), f₂(xₙ₋₂) (5B), f₃(xₙ₋₃) (5C), f₄(xₙ₋₄) (5D), f₅(xₙ₋₅) (5E) and f₆(xₙ₋₆) (5F) comprising respective shift modules (7A-7F) performing a 0, 5, 10, 15, 20 and 26 bit position shift to the right, respectively, of the results obtained by the six processing means;
an XOR logic gate (8) performing the bit-by-bit modulo 2 addition from the result obtained by the six processing means MP1 (6A), MP2 (6B), MP3 (6C), MP4(6D), MP5 (6E) and MP6 (6F) for processing six discrete chaotic maps f₁(xₙ₋₁) (5A), f₂(xₙ₋₂) (5B), f₃(xₙ₋₃) (5C), f₄(xₙ₋₄) (5D), f₅(xₙ₋₅) (5E) and f₆(xₙ₋₆) (5F);
six memory elements EM1 (4A), EM2 (4B), EM3 (4C), EM4 (4D), EM5 (4E) and EM6 (4F) storing the unpredictable pseudorandom numbers generated by the generator in the six previous moments “n−1”, “n−2”, “n−3”, “n−4”, “n−5” and “n−6” when the system has already been initialized, or six initialization values y₁ (10A), y₂ (10B), y₃ (10C), y₄ (10D), y₅ (10E) and y₆ (10F) with word sizes of 32 bits referred to as “seed” coming from the output register (10) when the system is initialized or the starting point is changed;
six commutators CM1 (2A), CM2 (2B), CM3 (2C), CM4 (2D), CM5 (2E) and CM6 (2F) which allow loading the six memory elements EM1 (4A), EM2 (4B), EM3 (4C), EM4 (4D), EM5 (4E) and EM6 (4F) with the six external values referred to as “seed” y₁ (10A), y₂ (10B), y₃ (10C), y₄ (10D), y₅ (10E) and y₆ (10F);
a first input connector (12A), a second input connector (12B), a third input connector (12C), a fourth input connector (12D), a fifth input connector (12E) and a sixth input connector (12F) for loading external values referred to as “seed” y₁ (10A), y₂ (10B), y₃ (10C), y₄ (10D), y₅ (10E) and y₆ (10F) in six commutators CM1 (2A), CM2 (2B), CM3 (2C), CM4 (2D), CM5 (2E) and CM6 (2F), as well as a load input connector (12Z) connecting the parallel load module (11) with the control input of the six commutators CM1 (2A), CM2 (2B), CM3 (2C), CM4 (2D), CM5 (2E) and CM6 (2F);
an output connector (13) connecting the output of the XOR logic gate (8) with the output register (9) for adding the unpredictable pseudorandom number “xₙ” generated in moment “n” to the sequence of numbers stored in said output register (9) and made up of the pseudorandom numbers generated in the previous moments.

The generator additionally comprises a generated number input connector (12Y) connecting the output connector (13) with the input of memory element EM1 (4A) storing the unpredictable pseudorandom number in moment “n−1” so that said element can be updated with the unpredictable pseudorandom number “xₙ”. In the same manner, memory elements EM1 (4A), EM2 (4B), EM3 (4C), EM4 (4D), EM5 (4E) and EM6 (4F) are interconnected to update their content when a new unpredictable pseudorandom number is generated, such that the content of each memory element is shifted to the memory element located immediately to its left, i.e., memory elements EM1 (4A), EM2 (4B), EM3 (4C), EM4 (4D) and EM5 (4E) send their respective contents to memory elements EM2 (4B), EM3 (4C), EM4 (4D), EM5 (4E) and EM6 (4F), respectively, where memory element EM1 (4A) further stores the new number generated after sending its content to memory element EM2 (4B) and where memory element EM6 (4F) discards its content before receiving the content of memory element EM5 (4E).

The six chaotic map processing means EM1 (4A), EM2 (4B), EM3 (4C), EM4 (4D), EM5 (4E) and EM6 (4F) compute the six functions f₁(xₙ₋₁) (5A), f₂(xₙ₋₂)(5B), f₃(xₙ₋₃) (5C), f₄(xₙ₋₄) (5D), f₅(xₙ₋₅) (5E) and F₆(xₙ₋₆) (5F) defining the discrete chaotic maps, said functions being:

f₁(xₙ₋₁)=[(a₁xₙ₋₁+c₁)mod 2³²]>>>0;

f₂(xₙ₋₂)=[(a₂xₙ₋₂+c₂)mod 2³²]>>>5;

f₃(xₙ₋₃)=[(a₃xₙ₋₃+c₃)mod 2³²]>>>10;

f₄(xₙ₋₄)÷[(a₄xₙ₋₄+c₄)mod 2³²]>>>15;

f₅(xₙ₋₅)=[(a₅xₙ₋₅+c₅)mod 2³²]>>>20;

f₆(xₙ₋₆)∓[(a₆xₙ₋₆+c₆)mod 2³²]>>>25;

the coefficients “a₁”, “a₂”, “a₃”, “a₄”, “a₅”, “a₆”, “c₁”, “c₂”, “c₃”, “c₄”, “c₅” and “c₆” being twelve randomly selected integers referred to as “key”; xₙ₋₁, xₙ₋₂, xₙ₋₃, xₙ₋₄, xₙ₋₅ and xₙ₋₆ being the unpredictable pseudorandom numbers generated in previous moments “n−1”, “n−2”, “n−3”, “n−4”, “n−5” and “n−6”, respectively, where “mod” is the modulus function, the operator “>>>rⱼ” is the cyclic shift “rⱼ” bit positions to the right function and where it is further found that 1≦aⱼ≦m and 1≦cⱼ≦m. In this implementation, each processing means comprise its own shift module for performing the shift function.

Therefore, the unpredictable pseudorandom number “xₙ” obtained in moment “n” is:

xₙ=[[f₁(xₙ₋₁)]⊕[f₂(xₙ₋₂)]⊕[f₃(xₙ₋₃)]⊕[f₄(xₙ₋₄)]⊕[f₅(xₙ₋₅)]⊕[f₆(xₙ₋₆)]];

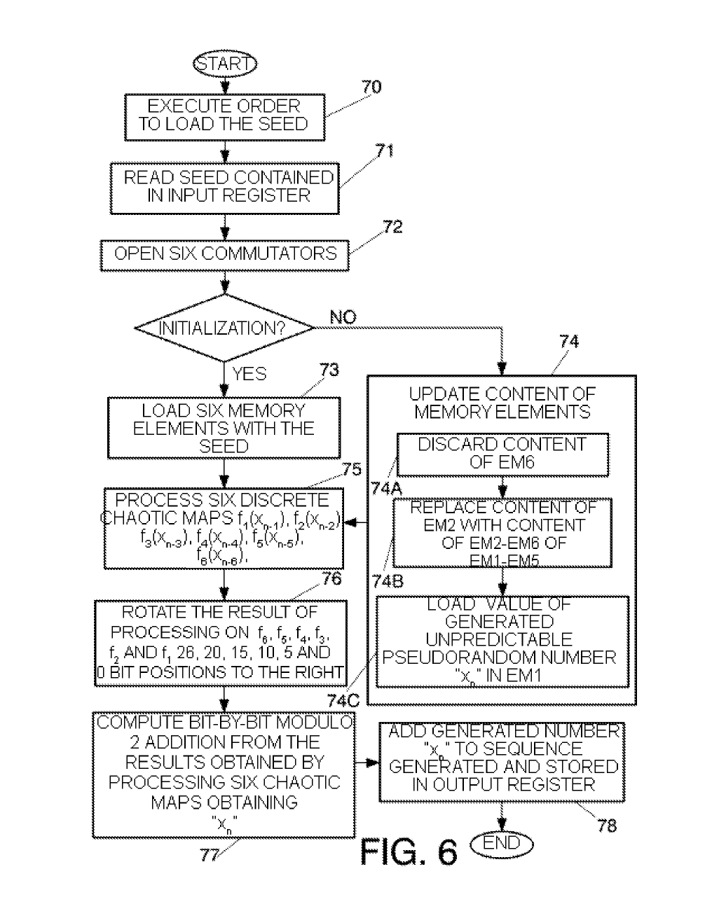

FIG. 6 shows a flow chart of the method for generating unpredictable pseudorandom numbers according to the present invention. Said flow chart depicts the method of the present invention for an implementation of the system shown in FIG. 5, i.e., for a system determined by a word size of 32 bits and six discrete chaotic maps. Said method shown in FIG. 6 with which the unpredictable pseudorandom numbers are obtained in a chaotic manner comprises the following steps:
i) executing (70) the order to load the initialization values referred to as “seed” in parallel from the parallel load module; ii) reading (71) initialization values y₁, y₂, y₃, y₄, y₅ and y₆ referred to as “seed” in the input register, each value y₁, y₂, y₃, y₄, y₅ and y₆ comprising a word length of 32 bits; iii) opening (72) commutators CM1, CM2, CM3, CM4, CM5 and CM6;
iv) loading (73) memory elements EM1, EM2, EM3, EM4, EM5 and EM6 with initialization values y₁, y₂, y₃, y₄, y₅ and y₆ in parallel if the system is initialized or if changing the starting point of the generated sequence is required;
v) updating (74) the content of memory elements EM1, EM2, EM3, EM4, EM5 and EM6: discarding (74A) the content of memory element EM6 containing the unpredictable pseudorandom number generated in moment “n−6”, replacing (74B) the content of EM2-EM6 with the content of memory element EM1-EM5, and loading (74C) memory element EM1 with the last value of the unpredictable pseudo-chaotic number generated “xₙ” when the system is not initialized;
vi) processing (75) six discrete chaotic maps f₁(xₙ₋₁), f₂(xₙ₋₂), f₃(xₙ₋₃), f₄(xₙ₋₄), f₅(xₙ₋₅) and f₆(xₙ₋₆) by means of six processing means MP1, MP2, MP3, MP4, MP5 and MP6;
vii) rotating (76) the result obtained from processing chaotic maps f₁(xₙ₋₁), f₂(xₙ₋₂), f₃(xₙ₋₃), f₄(xₙ₋₄), f₅(xₙ₋₅) and f₆(xₙ₋₆) 0, 5, 10, 15, 20 and 26 bit positions to the right;
viii) computing (77) the bit-by-bit modulo 2 addition, XOR, from the result obtained in the two preceding steps, generating a new unpredictable pseudorandom number “xₙ”;
ix) adding (78) the generated unpredictable pseudorandom number “xₙ” to the sequence generated and stored in the output register.

Steps i) to iv) described above are only performed once for initializing the system or for changing the starting point. In contrast, steps v) to ix) are loop executed until the generated sequence contains the amount of unpredictable pseudorandom numbers established by a predetermined number. Said predetermined number must be less than the period P of the generator.

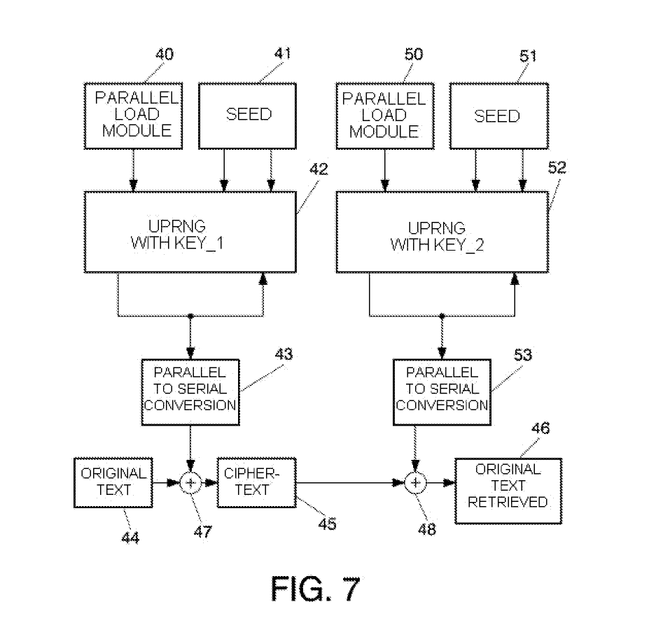

FIG. 7 shows an implementation example of the present invention applied to a stream cipher device comprising in transmission at least one parallel load module (40), an input register with seed_1 (41), an unpredictable pseudorandom number generator, UPRNG, (42) and a parallel to serial converter (43) which obtains a ciphertext (45) of the original text (44) when applied (47) to said original text (44). However at reception, the implementation comprises at least one parallel load module (50), an input register with seed_1 (51), an unpredictable pseudorandom number generator, UPRNG, (52) and a parallel to serial converter (53) which returns the retrieved original text (46) when applied (48) to the ciphertext (45).

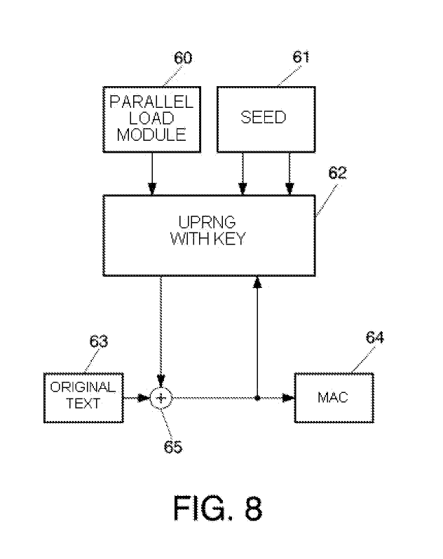

FIG. 8 shows an implementation example of the present invention applied to a Message Authentication Code (MAC) generator device. Said device comprises at least one parallel load module (60), an input register with the seed (61) and an unpredictable pseudorandom number generator, UPRNG, (62) which returns a message authentication code (64) when applied (65) to the original text (44).

1. A method for generating unpredictable pseudorandom numbers in a chaotic manner, characterized in that for predetermined implementation values comprising at least one word size “S” and a number of discrete chaotic maps “k”, said number of discrete chaotic maps being at least 2 in number, said method comprises at least the following steps:
i) executing an order to load “k” initialization values referred to as “seed” in parallel from a parallel load module, each initialization value comprising a word length of “S” bits;
ii) reading “k” initialization values referred to as “seed” in an input register;
iii) opening “k” commutators;
iv) loading “k” memory elements with “k” initialization values in parallel when an action selected from starting the system and changing the starting point of a generated sequence is required;
v) updating the content of “k” memory elements numbered one to “k” which, for an implementation in which said memory elements are each interconnected with the following element; where the last element with number “k” is not connected to any other element, and where memory element number one receives at its input the unpredictable pseudorandom number generated by means of the following sub-steps:
discarding the content of memory element number “k”;
moving the content of each memory element “h” to memory element number “h+1” for values of “h” such that 1≦h≦k; and,
loading memory element number “k” with the last value of the unpredictable pseudo-chaotic number generated “xₙ”;
when the system has previously been initialized;
vi) processing “k” discrete chaotic maps fₖ(xₙ₋ₖ) by means of “k” processing means; “k” chaotic maps being those defined by:
fⱼ(xₙ₋ⱼ)=[(aⱼxₙ₋ⱼ+cⱼ)mod m]>>>rⱼ;
wherein “aⱼ” and “cⱼ” are two randomly selected integers referred to as “key”; “rⱼ” and “m” are two integers; operator “mod” represents the modulus function; operator “>>>” represents the cyclic shift to the right function; and where the values of the key must verify that 1≦aⱼ≦m and 1≦cⱼ≦m; for all the values of “j” comprised between 1 and “k”, both included;
vii) computing the bit-by-bit modulo 2 addition, XOR, of the result of processing “k” chaotic maps, generating a new unpredictable pseudorandom number “xₙ”:
xₙ=[f₁(xₙ₋₁)]⊕ . . . ⊕[fₖ(xₙ₋ₖ)];
viii) adding the generated unpredictable pseudorandom number “xₙ” to the sequence generated and stored in the output register;
where steps i) to iv) described above are furthermore only performed once to carry out an action selected from initializing the system and changing the starting point of the generated sequence, and where steps v) to viii) are loop executed until the generated sequence contains the amount of unpredictable pseudorandom numbers established by a predetermined number.

2. A system for generating unpredictable pseudorandom numbers in a chaotic manner, characterized in that for predetermined implementation values comprising at least one word size “S” and a number of discrete chaotic maps “k”, it comprises at least:
a chaotic-based unpredictable pseudorandom number generator;
a parallel load module;
an output register storing the generated sequence comprised by concatenating the generated numbers; and,
an input register storing “k” initialization values y₁ to yₖ, said initialization values being referred to as “seed”.

3. The system for generating unpredictable pseudorandom numbers in a chaotic manner according to claim 2, characterized in that the chaotic-based unpredictable pseudorandom number generator additionally comprises at least:
“k” processing means MP1 to MPK for processing “k” discrete chaotic maps f₁(xₙ₋₁) to fₖ(xₙ₋ₖ), fⱼ(xₙ₋ⱼ) being:
fⱼ(xₙ₋ⱼ)=[(aⱼxₙ₋ⱼ+cⱼ)mod m]>>>rⱼ
where the coefficients “aⱼ” and “cⱼ” are two randomly selected integers referred to as “key” such that 1≦aⱼ≦m, 1≦cⱼ≦m; xₙ₋ⱼ is the random number generated in the previous moment “n−j”; “rⱼ” and “m” two integers; “mod” the modulus function; “j” an integer such that 1≦j≦k; operator “>>>” the shift to the right function;
an XOR logic gate performing the bit-by-bit modulo 2 addition from the result obtained by “k” processing means MP1 to MPK for processing “k” discrete chaotic maps f₁(xₙ₋₁) to fₖ(xₙ₋ₖ), obtaining the unpredictable pseudorandom number xₙ:
xₙ=[f₁(xₙ₋₁)]⊕ . . . ⊕[fₖ(xₙ₋ₖ)];
a cyclic shift module computing the shift to the right in “rⱼ” bits of the binary number obtained when the discrete chaotic map fⱼ(xₙ₋ⱼ) is processed by the processing means “j”, “j” being a number such that 1≦j≦k; said cyclic shift module is located in a location option selected from a location comprised in each of “k” processing means and a location independent of said cyclic shift module connected to “k” processing means and to the XOR logic gate;
“k” memory elements, EM1 to EMK storing data selected from the last “k” unpredictable pseudorandom numbers generated by the generator when the system has already been initialized, and “k” initialization values y₁ to yₖ with word sizes of “S” bits referred to as “seed” coming from the input register when an action selected from initializing the system and changing the starting point is performed;
“k” commutators CM1 to CMK which allow loading “k” memory elements EM1 to EMK with “k” external values referred to as “seed” y₁ to yₖ;
an output connector connecting the output of the XOR logic gate with the output register for adding the unpredictable pseudorandom number “xₙ” generated in moment “n” to the sequence of numbers stored in said output register and made up of the pseudorandom numbers generated in the previous moments; and,
“k” input connectors for loading “k” initialization values y₁ to yₖ referred to as “seed” in “k” commutators CM1 to CMK, as well as a load input connector connecting the parallel load module with the control input of “k” commutators CM1 to CMK, and a generated number input connector connecting the output connector with the input of memory element number one EM1.
